(19) United States
(12) Patent Application Publication
(10) Pub. No.: US 2010/0191644 A1
(43) Pub. Date: Jul. 29, 2010

(54) COMMUNITY COVENANT RULES AND GUIDELINES ENFORCEMENT SYSTEM AND METHOD

(76) Inventor: Francois Perreault, Mesa, AZ (US)

Correspondence Address: FRANCOIS PERREAULT, PO BOX 30538, MESA, AZ, 85275, US

(21) Appl. No.: 12/683,678

(22) Filed: Jan. 7, 2010

Related U.S. Application Data
(60) Provisional application No. 61/148,038, filed on Jan. 28, 2009.

(51) Int. Cl. G06Q 99/00; G06Q 40/00; G01S 19/13; G06F 15/16; G06F 3/048

(52) U.S. Cl. 705/39; 705/1.1; 342/357.06; 709/203; 715/764; 715/760

(57) ABSTRACT

A method of enforcing community covenant rules and guidelines by managing events within a community using a computer system, the method comprising providing a plurality of potential violation events; selecting at least one potential violation event from the plurality of violation events; associating a violation event remedy to the selected at least one potential violation event; and associating a optional delay with the associated violation event remedy, the at least one violation event remedy being adapted to be enforced when the optional delay associated therewith is expired. A system and a user graphical interface providing same are also provided herein.

### CROSS-REFERENCE

This United States Patent application relates to and claims priority from U.S. Provisional Patent application No. 61/148,038, filed Jan. 28, 2009, entitled COMMUNITY COVENANT RULES MANAGEMENT SYSTEM AND METHOD, incorporated herein by reference in its entirety.

### FIELD OF THE INVENTION

This invention relates to a method and a system for enforcing community covenant rules and guidelines, and specifically relates to the violation of community rules and guidelines within the community.

### BACKGROUND OF THE INVENTION

Communities usually consist of streets, buildings and might include various amenities. Each community can contain controlled entrances for pedestrians, bicycles and automobiles, and sometimes characterized by a closed perimeter of walls and fences. Communities are a type of common interest infrastructure and can provide specific rights and privileges to the owners.

Each community has to comply with some Federal, State, County and City regulations. Most of the time, communities possess their own covenant rules and guidelines, which define, accepted rights and privileges of aspects of the life and accepted behaviors in the community. A community representative(s) is generally named or elected and is responsible to keep proper order in the community. A set of covenant rules and guidelines can be written, which the people entering the community shall comply with.

It incomes to the community representative(s) to enforce the covenant rules and guidelines; and to maintain proper order within the community. This can rapidly become a challenge for the community representative(s) and some aspects are often subcontracted to third parties. It is unlikely that the community's representative(s) can manage all of day-to-day activities and the violations to the community covenant rules and guidelines. Even if the community representative(s) could do so, the means for correcting violations would most likely be limited. This is a reason, inter a/ia, why the enforcement of community rules and guidelines violations is given to a specialized third party sub-contractor.

Subcontracting the enforcement of community rules and guidelines implies that the community representative(s) shares the subject rules with the relevant sub-contractor and makes sure they will be enforced in a desired fashion. It also means that the subject rules need to be updated from time to time and that the most recent subject rules should be transmitted to the proper sub-contractor in due time. On the other hand, the community representative(s) needs to be aware of any defaults, problems, issues found and issues remedied by the sub-contractor. It rapidly becomes a challenge for both the community representative(s) and the sub-contractor to keep each other informed.

### SUMMARY OF THE INVENTION

It is one aspect of the present invention to alleviate one or more of the drawbacks of the background art by addressing one or more of the existing needs in the art.

Accordingly, one object of one or more embodiments of this invention provides an improved communities rules and guidelines enforcement method and system over the prior art.

One object of the present invention provides a method adapted to be carried out as a series of steps enabled in a computerized system for managing covenant rules, guidelines and associated violations.

Another object of the present invention provides a computerized community covenant rules and guidelines enforcement system adapted to manage activities and behaviors data within a community.

One object of the present invention provides a graphical user interface adapted to easily and efficiently construct and/or customize rules, record associated violation events, and associated violation event remedies.

An object of the present invention provides a method of sharing data between community representative(s) and sub-contractors hired to enforce community covenant rules and guidelines.

One aspect of the present invention provides a network-centered computer system adapted to allow authorized users to easily and efficiently construct rules and/or customize, violation event and violation event remedies adapted to be associated therewith.

Another aspect of the present invention provides a method adapted to associate a violation event remedy to a potential violation event resulting from the failure to comply with the community's rules and guidelines.

One other aspect of the present invention provides a method adapted to associate a plurality of violation event remedies to a potential violation event. The plurality of violation event remedies can be sequentially enabled.

Another aspect of the present invention provides a method of enforcing community covenant rules and guidelines by managing events within a community using a computer system, the method comprising providing a plurality of potential violation events; selecting at least one potential violation event from the plurality of potential violation events; and associating a violation event remedy with the selected at least one potential violation event.

One additional aspect of the present invention provides a user graphical interface adapted to display controls for managing enforcement of community covenant rules, the user graphical interface comprising a potential violation events display area adapted to display a plurality of user-selectable potential violation events; a violation event remedies display area adapted to display a plurality of user-selectable violation event remedies; and an optional delay display area adapted to receive instructions defining a delay adapted to be associated with a violation event remedy.

One aspect of the present invention provides a system for enforcing community covenant rules and guidelines comprising a user interface module adapted to receive instructions from a user; a violation events module adapted to receive instructions from the user interface module; a violation event remedies module adapted to receive instructions from the user interface module; a delay module adapted to receive instructions from the user interface module.

Other objects and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Referring now to the drawings, which form a part of this original disclosure:

FIG. 1 is an illustrative schematic diagram of a computer network in accordance with at least one possible embodiment of the present invention;

FIG. 2 is an illustrative schematic diagram of a computer network in accordance with at least one possible embodiment of the present invention;

FIG. 3 is an illustrative schematic diagram of a computer device in accordance with at least one possible embodiment of the present invention;

FIG. 4 is an illustrative exemplary flow chart of exemplary steps that are generally performed when a third party is subcontracted to enforce community covenant rules and guidelines in accordance with at least one possible embodiment of the present invention;

FIG. 5 is a schematic exemplary illustration of a computer network interconnecting various communities with third parties via a networked based system in accordance with at least one possible embodiment of the present invention;

FIG. 6 is a schematic exemplary illustration of steps required to associate a violation event with a violation remedy and an optional delay in accordance with at least one possible embodiment of the present invention;

FIG. 7 is a schematic exemplary illustration of plurality of possible inputs and outputs interacting together to form a system in accordance with at least one possible embodiment of the present invention;

FIG. 8 is a schematic exemplary illustration of steps performed when a violation event is noticed and entered in the system in accordance with at least one possible embodiment of the present invention;

FIG. 9 is a schematic exemplary illustration of a bloc diagram depicting a plurality of possible modules in accordance with at least one possible embodiment of the present invention;

FIG. 10 is a schematic exemplary illustration of an exemplary bloc diagram depicting a plurality of possible sub-modules in accordance with at least one possible embodiment of the present invention;

FIG. 11 is a schematic exemplary illustration of an exemplary user interface in accordance with at least one possible embodiment of the present invention;

FIG. 12 is a non-exhaustive illustrative list of potential violation events in accordance with possible embodiments of the present invention; and

FIG. 13 illustrates a non-exhaustive illustrative list of potential violation event remedies in accordance with possible embodiments of the present invention.

### DETAILED DESCRIPTION OF PREFERRED EMBODIMENTS

A preferred and non-limitative embodiment of the present invention is described bellow with reference to the drawings. The following illustrative examples are preferably adapted to be carried out on a computer system. The computer system can be a stand-alone computer or a network of computers interacting together through Internet, intranet or VPN.

Exemplary Network

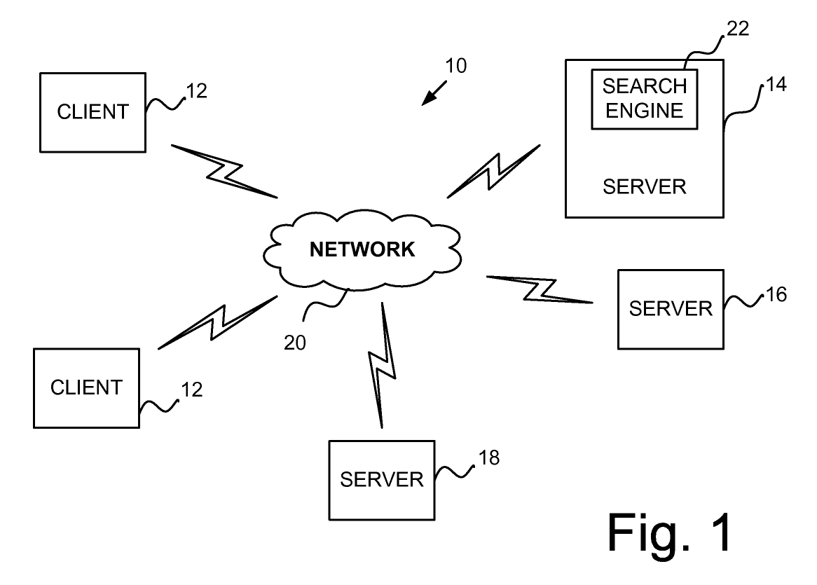

FIG. 1 illustrates an exemplary network 10 in which a system and method, consistent with the present invention, may be implemented. The network 10 may include multiple client devices 12 connected to multiple servers 14, 16, 18 via a network 20. The network 20 may include a local area network (LAN), a wide area network (WAN), a phone network, such as the Public Switched Phone Network (PSTN), an intranet, the Internet, Wi-Fi, WiMAX or a combination of networks. Two client devices 12 and three servers 14, 16, 18 have been illustrated connected to network 20 for simplicity. In practice, there may be more or less client devices and servers. Also, in some instances, a client device may perform the functions of a server and a server may perform the functions of a client device.

The client devices 12 may include devices, such as mainframes, minicomputers, personal computers, laptops, personal digital assistants, cell phones, or the like, capable of connecting to the network 20. The client devices 12 may transmit data over the network 20 or receive data from the network 20 via a wired, wireless, or optical connection.

The servers 14, 16, 18 may include one or more types of computer system, such as a mainframe, minicomputer, or personal computer, laptops, personal digital assistants, cell phones, or the like, capable of connecting to the network 20 to enable servers 14, 16, 18 to communicate with the client devices 12. In alternative implementations, the servers 14, 16, 18 may include mechanisms for directly connecting to one or more client devices 12. The servers 14, 16, 18 may transmit data over network 14 or receive data from the network 20 via a wired, wireless, or optical connection.

In an implementation consistent with the present invention, the server 14 may include a search engine 22 usable by the client devices 12. The servers 14 may store documents, such as web pages, accessible by the client devices 12.

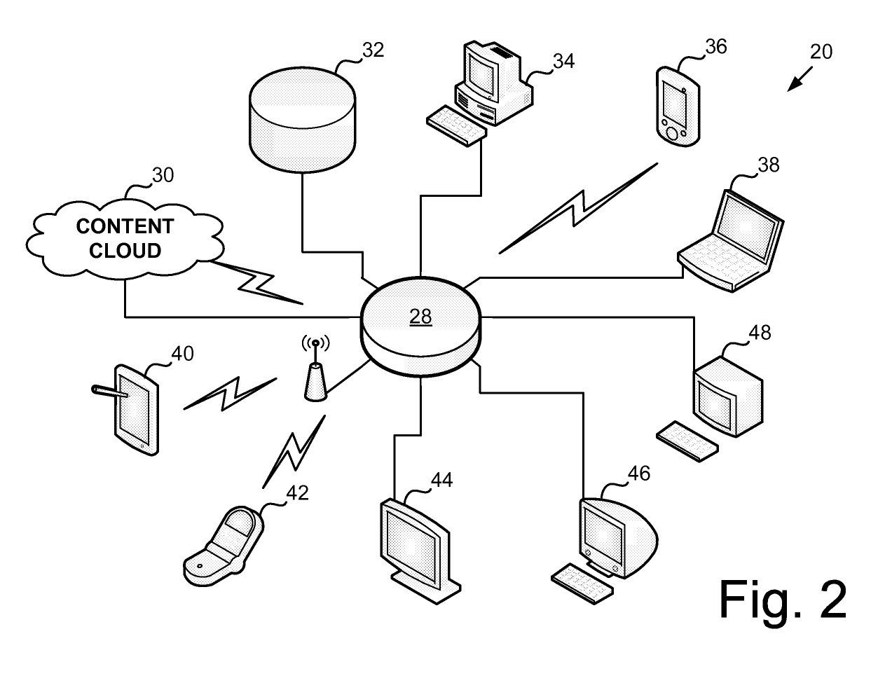

With reference to FIG. 2, a network 20 includes a content cloud 30, a content database 32, content devices 34-38, and devices 40-48. The network mediator 28 enables the network devices 32-38 to communicate with each other without pre-configuring each device. The content cloud 30 represent a content source such as the Internet, where content exists at various distributed locations across the globe and even further like in space. The content includes documents and multimedia content such as audio and video. The mediator 28 allows the content cloud to provide content to devices 40-48. The content database 32 is a storage device that maintains content. The content database 32 may be a stand-alone device on an external communication network. The mediator 28 communicates with the content database 32 to access and retrieve content. The content devices 34-38 include intelligent devices, such as, for example, personal computers, laptops, cell phones and personal digital assistants. The content devices 32-38 are capable of storing content data. The devices 40-48 are intelligent devices that receive content from a content source 30-38. However, the devices 30-38 can also operate as servers to distribute content to other client devices.

The following discussion provides a brief, general description of an exemplary apparatus in which at least some aspects of the present invention may be implemented. The present invention will be described in the general context of computer-executable instructions, such as program modules, being executed by a computerized device. However, other apparatus may affect the methods of the present invention. Program modules may include routines, programs, objects, components, data structures, applets, WEB 2.0 type of evolved networked centered applications, etc. that perform a task(s) or implement particular abstract data types. Moreover, these skilled in the art will appreciate that at least some aspects of the present invention may be practiced with other configurations, including hand-held devices, multiprocessor system, microprocessor-based or programmable consumer electronics, network computers, minicomputers, set top boxes, mainframe computers, personal computers, laptops, personal digital assistants, cell phones, gaming console and the like. At least some aspects of the present invention may also be practiced in distributed computing environments where tasks are performed by remote processing devices linked through a communications network. In a distributed computing environment, program modules may be located in local and/or remote memory storage devices.

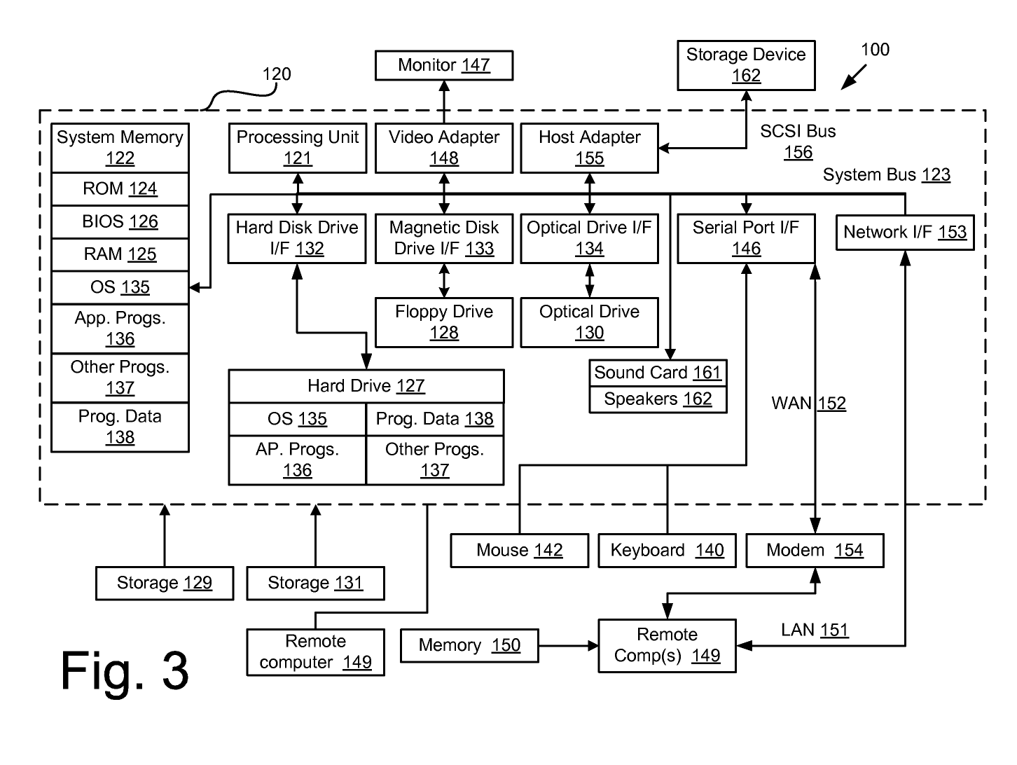

With reference to FIG. 3, an exemplary apparatus 100 for implementing at least some aspects of the present invention includes a general purpose computing device in the form of a conventional personal computer 120 or in the form of a computerized portable apparatus. The computer 120 may include a processing unit 121, a system memory 122, and a system bus 123 that couples various system components, including the system memory 122, to the processing unit 121. The system bus 123 may be any of several types of bus structures including a memory bus or memory controller, a peripheral bus, and a local bus using any of a variety of bus architectures. The system memory may include read only memory (ROM) 124 and/or random access memory (RAM) 125. A basic input/output system 126 (BIOS), containing basic routines that help to transfer data between elements within the personal computer 120, such as during start-up, may be stored in ROM 124. The personal computer 120 may also include a hard disk drive 127 for reading from and writing to a hard disk, (not shown), a magnetic disk drive 128 for reading from or writing to a (e.g., removable) magnetic disk 129, and an optical disk drive 130 for reading from or writing to a removable (magneto) optical disk 131 such as a compact disk or other (magneto) optical media. The hard disk drive 127, magnetic disk drive 128, and (magneto) optical disk drive 130 may be coupled with the system bus 123 by a hard disk drive interface 132, a magnetic disk drive interface 133, and a (magneto) optical drive interface 134, respectively. The drives and their associated storage media provide nonvolatile (or persistent) storage of machine-readable instructions, data structures, program modules and other data for the personal computer 120. Although the exemplary environment described herein employs a hard disk, a removable magnetic disk 129 and a removable optical disk 131, these skilled in the art will appreciate that other types of storage media, such as magnetic cassettes, flash memory cards, digital video disks, Bernoulli cartridges, random access memories (RAMs), read only memories (ROM), and the like, may be used instead of, or in addition to, the storage devices introduced above.

A number of program modules may be stored on the hard disk 127, magnetic disk 129, (magneto) optical disk 131, ROM 124 or RAM 125, such as an operating system 135 (for example, Windows® NT.RTM. 4.0, sold by Microsoft® Corporation of Redmond, Wash.), one or more application programs 136, other program modules 137 (such as “Alice”, which is a research system developed by the User Interface Group at Carnegie Mellon University available at www.Alice.org, OpenGL from Silicon Graphics Inc. of Mountain View Calif., or Direct 3D from Microsoft Corp. of Bellevue Wash.), and/or program data 138 for example.

A user may enter commands and data into the personal computer 120 through input devices, such as a keyboard 140, a camera 141 and pointing device 142 for example. Other input devices (not shown) such as a microphone, joystick, game pad, satellite dish, scanner, a touch sensitive screen, accelerometers adapted to sense movements of the user or movements of a device, or the like may also be included. These and other input devices are often connected to the processing unit 121 through a serial port interface 146 coupled to the system bus. However, input devices may be connected by other interfaces, such as a parallel port, a game port, blue tooth connection or a universal serial bus (USB). For example, since the bandwidth of the camera 141 may be too great for the serial port, the video camera 141 may be coupled with the system bus 123 via a video capture card (not shown). The video monitor 147 or other type of display device may also be connected to the system bus 123 via an interface, such as a video adapter 148 for example. The video adapter 148 may include a graphics accelerator. One or more speaker 162 may be connected to the system bus 123 via a sound card 161 (e.g., a wave table synthesizer such as product number AWE64 Gold Card from Creative® Labs of Milpitas, Calif.). In addition to the monitor 147 and speaker(s) 162, the personal computer 120 may include other peripheral output devices (not shown), such as a printer for example. As an alternative or an addition to the video monitor 147, a stereo video output device, such as a head mounted display or LCD shutter glasses for example, could be used.

The personal computer 120 may operate in a networked environment, which defines logical connections to one or more remote computers, such as a remote computer 149. The remote computer 149 may be another personal computer, a server, a router, a network PC, a peer device or other common network node, and may include many or all of the elements described above relative to the personal computer 120, although only a memory storage device has been illustrated in FIG. 3. The logical connections depicted in FIG. 2 include a local area network (LAN) 14 and a wide area network (WAN) 152, an intranet and the Internet.

When used in a LAN, the personal computer 120 may be connected to the LAN 14 through a network interface adapter (or “NIC”) 153. When used in a WAN, such as the Internet, the personal computer 120 may include a modem 154 or other means for establishing communications over the wide area network 152 (e.g. Wi-Fi, WinMax). The modem 154, which may be internal or external, may be connected to the system bus 123 via the serial port interface 146. In a networked environment, at least some of the program modules depicted relative to the personal computer 120 may be stored in the remote memory storage device. The network connections shown are exemplary and other means of establishing a communications link between the computers may be used.

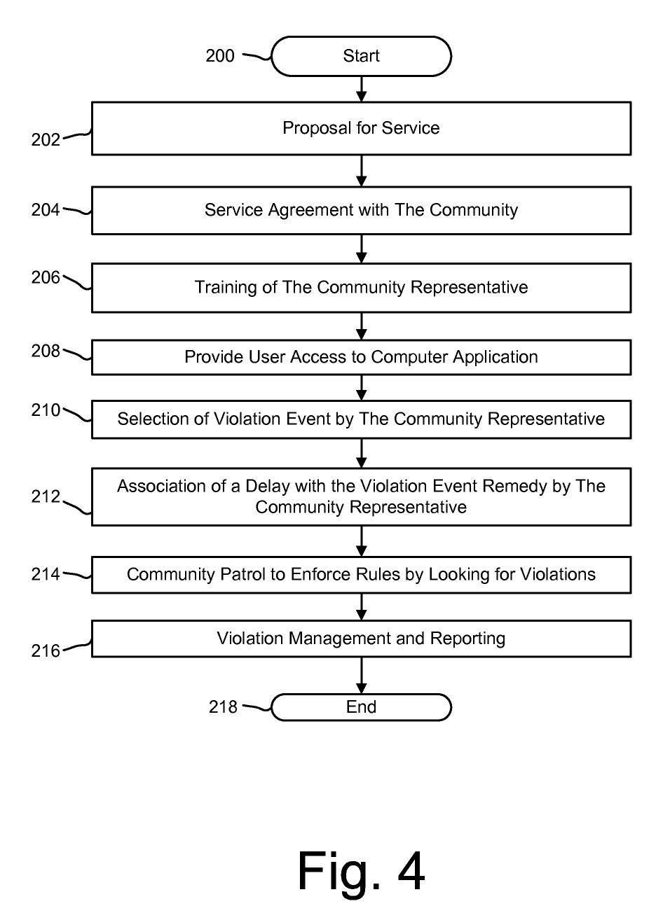

FIG. 4 is an illustrative flow chart of exemplary steps that are generally performed when a third party subcontracts enforcement of community covenant rules and guidelines The illustrative series of steps begin 200 with a proposal for service 202 to the community, likely via a community's representative. In the context of the present disclosure a community representative can include: one or more community representatives, a property manager, a property management company and its agent, a board of directors, other sub-contractors and employees of the community deemed to have the authority to act on the behalf of the community. A service agreement is agreed with the community 204 and the community's representative is trained 206 to use the computer system carrying out at least some embodiments of the present application through a computer application. The community representative is provided with proper user access to the system 208. The community representative provides the sub-contractor with a selection of violation event 210. The community representative associates optional delay(s) 212 with the selection of violation event 210. The sub-contractor complete physical or electronic (via cameras) community patrols 214 as stated in the service agreement 204 linking the sub-contractor with the community. The sub-contractor and the community representative use the computer program to counsel, manage and report violations data 216 before the series of illustrative steps ends 218. Violation data can be in the form of written notes, selecting a desired choice from a drop down menu on the computer system of predetermined possible violations, pictures, video, geographical location and sound (voice or other).

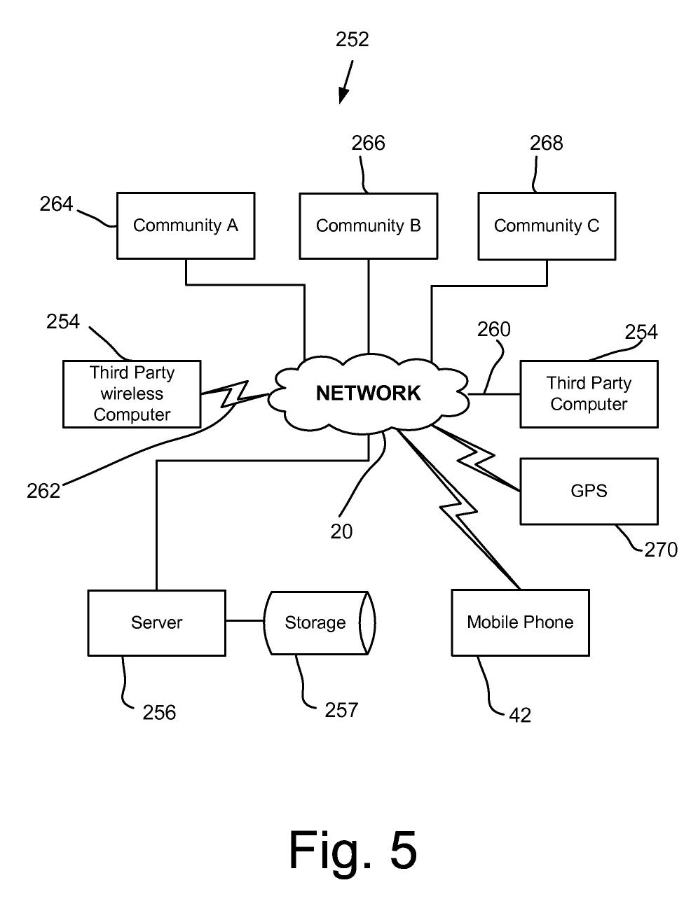

FIG. 5 is an illustrative schematic exemplary computer network 250 connecting a plurality of communities 252 with the third party 254 empowered to enforce covenant community rules and guidelines in accordance with an embodiment of the present invention. In the illustrative embodiment, the third party uses a server 256 to give access to clients to a computer program adapted to execute machine-readable code stored on a storage 257. The server 256 is adapted to provide the application through a private or public network 258. Clients preferably get access to the functions of the present invention through a user graphical interface. Through the GPS interface 270, location, date and time data of events can be uploaded or transmitted in another way to the network 258. Third party's computers, either wiredly connected 260 or using a wireless connection 262, are interacting with the application. Each community, community A 264, community B 266 and community C 268 are also connected to the network 20 to access the computer program. The third party 254 and each of communities A 264, B 266, C 268 get access to a set of functions adapted to their respective needs in the application that are enabled in accordance with their respective service agreements 204, shown in FIG. 4, defining the scope of service between the third party and the communities 264, 266, 268 as illustrated in FIG. 5.

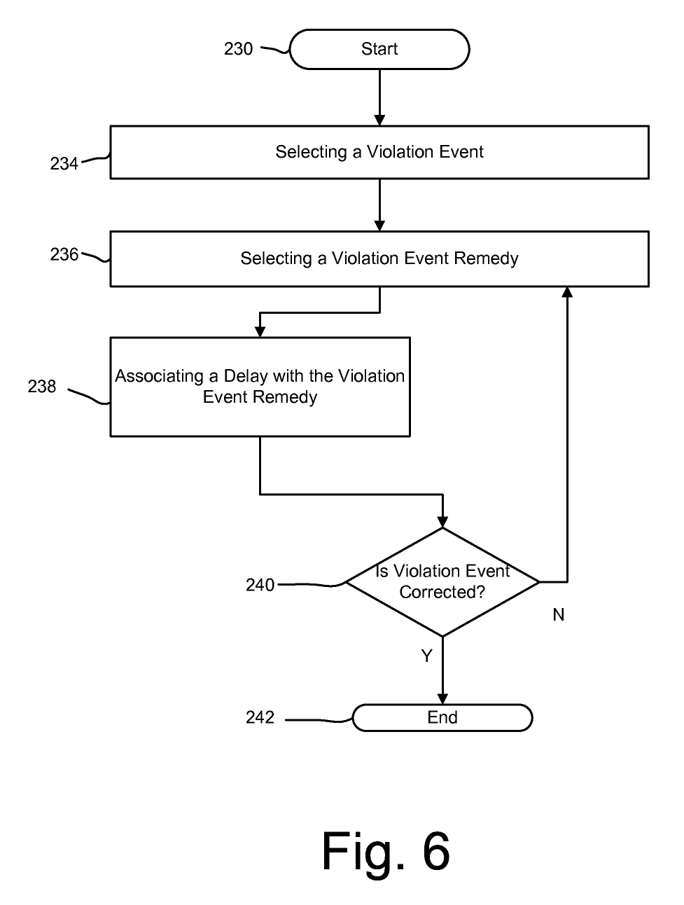

The next flow chart depicted in FIG. 6 illustrates how a violation event is managed by the application; more precisely how the application is built to associate a violation event with a violation event remedy. The exemplary suite of steps begins 230 with the selection of a violation event 234 from a list representative of possible violation events that can be found during the patrol of the community. The violation event remedy is associated 236 with the selected violation event 234. A delay 238 is optionally associated with the selected violation event remedy to make sure the remedy is not applied before it is required. In other words, one might be allowed to park a car for a duration of 2 hours and after that the car is violating the 2-hour parking rule. In the event the violation is not corrected after a first remedy 236 has been applied 240 thereon a second violation event remedy 236 can be added with a second delay 238 and so on so forth until the violation event ends 242.

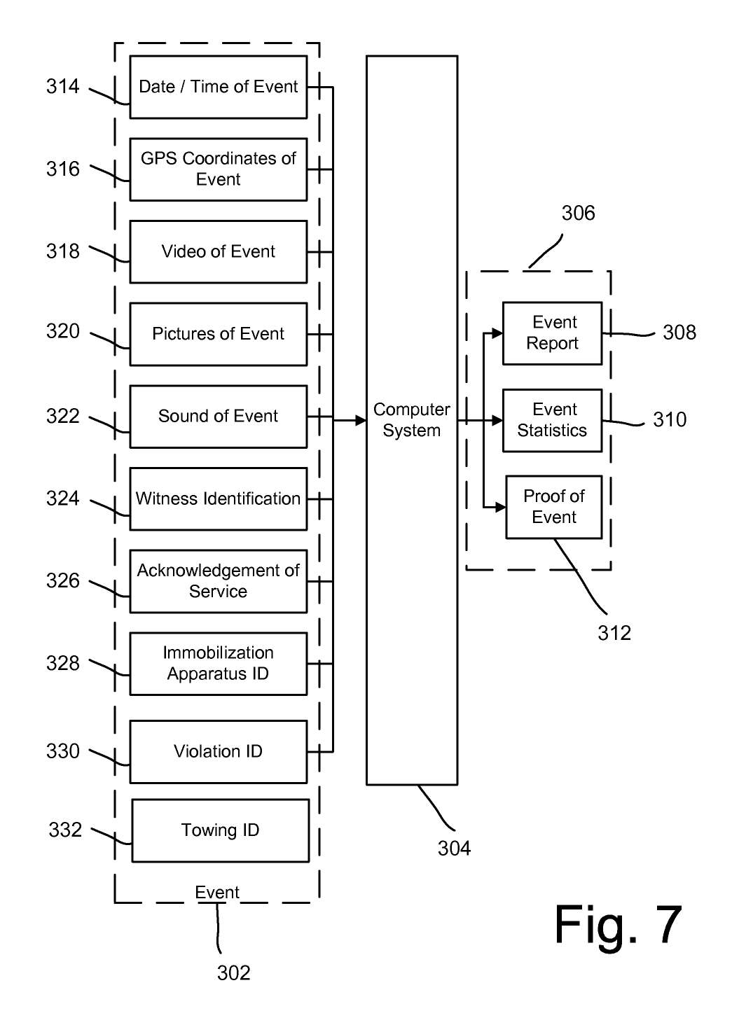

FIG. 7 is a schematic illustration of a plurality of potential inputs and outputs in accordance with at least one embodiment of the present invention. Events 302 might be associated with a plurality of attributes that can be put in the system 304. A date and time of event 314 is inputted in the system with each event. This date and time tag helps to identify events along a timeline if needed. A location input 316 uses a GPS to location tag each event in order to associate an event with a geographical location. Events can be filed and the resulting video data 318 is another optional input as a possible evidence of the violation. Pictures of events 320 and sound of event 322 are also additional inputs that can be associated with an event by the system 304. Witness identification 324 is generally typed in the system and is another type of inputs to the system 304. An acknowledgement of service 326 can be inputted with the system 304. A boot ID 328 (vehicle immobilization device) is possibly associated with an event and is inputted in the system 304. Finally, a violation ID 330 is another input to the system for providing an event 302 with a unique alpha-numeral identification. Alternatively the violation ID 330 can be automatically assigned to an event by the computer system. On the other side, the system 304 outputs event report 308, event statistics 310 and proof of events 312. The user may provide instructions to the computer system to produce an output 306 (e.g. an event report 308 and/or an event remedy report and/or proof(s) of event 312). Each event 312, date/time of event 314, GPS coordinates of event 316, video of event 318, pictures of event 320, sound of event 322, witness identification 324, acknowledgement of service 326, boot ID 328, violation ID 330 and towing ID 332 can be inputted in the computer system 304 and can be use in the reports 308, 310, 312. This information is useful to the community representative to understand the situation and make better decisions.

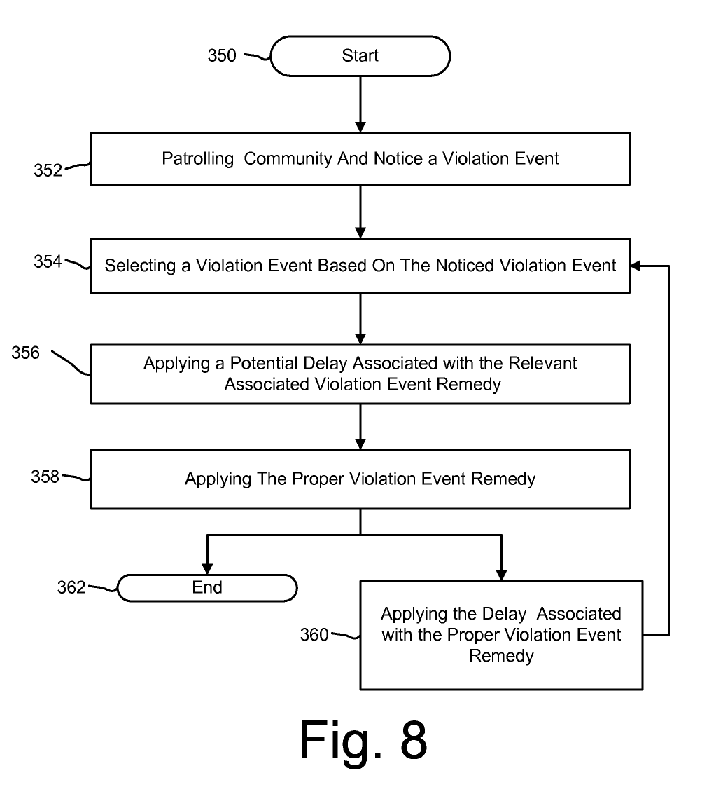

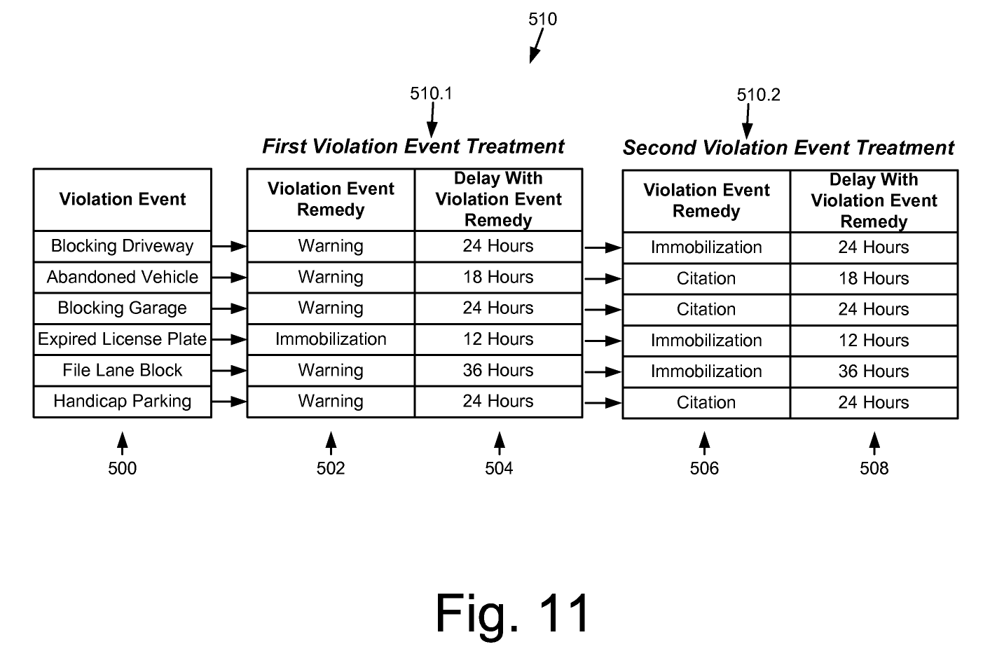

Turning now to FIG. 8 providing an illustrative flow chart of exemplary steps in accordance with an embodiment of the present invention. The process begins 350 with a third party patrolling a community lot 352 where a violation is noticed. The patrol uses the computer application described above to retrieve the community where the violation occurs and further select the type of violation that is ongoing 354. Once the violation is retrieved, the computer application then provides a list of potential violation event remedies 354 that can be selected in the current circumstance. The community representative, who has prescribed possible delays 356 and violation remedies in association with the ongoing violation, has predetermined which action(s) should be made and when each action should be performed. In accordance with the instructions provided by the application, the user interface then indicates the potential delay 356 to be observed with the proper violation remedy 358. It has to be noted that sometimes more than a single violation event remedy can be applied 358 if the violation event is not corrected within the predetermined delay. For doing so an additional delay 360 following the application of the violation remedy can optionally be added. The process ends 362 when the violation event is corrected. Conversely, if the additional delay 360 expires and the violation event is still occurring and noticed a second time 354 the sequence of steps can be repeated to apply a second remedy 356. This chain of violation remedies when a violation event is not corrected will be exemplified in further details in FIG. 11.

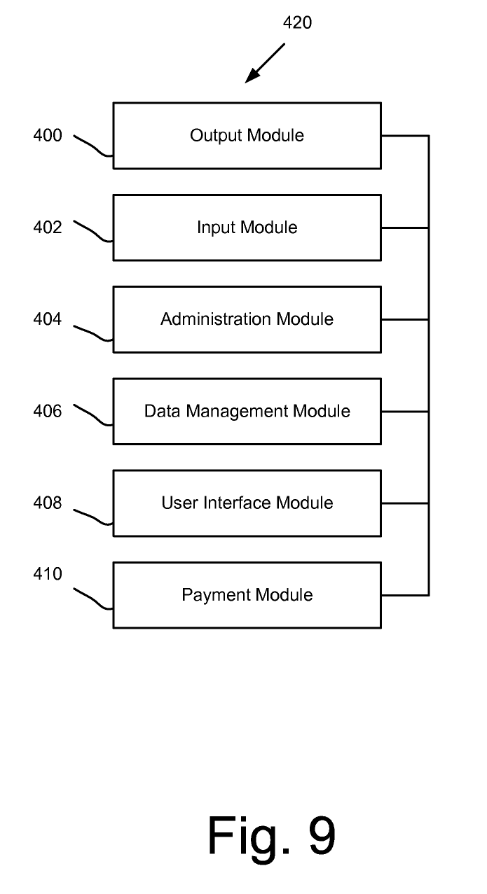

FIG. 9 is a schematic illustration of an exemplary bloc diagram depicting a plurality of program modules 420 in accordance with an embodiment of the present invention. A user may use one or more program modules 420 when using the application. The program module includes an output module 400, an input module 402, an administration module 404, a data management module 406, a user interface 408 and a payment module 410. Program modules may include routines, programs, objects, components, data structures, applets, WEB 2.0 type of evolved networked centered applications, etc. that perform a task(s) or implement particular abstract data types. Moreover, those skilled in the art will appreciate that at least some aspects of the present invention may be practiced with other configurations, including hand-held devices, multiprocessor system, microprocessor-based or programmable consumer electronics, network computers, minicomputers, set top boxes, mainframe computers, personal computers, laptops, personal digital assistants, mobile phones 42, gaming console and the like. At least some aspects of the present invention may also be practiced in distributed computing environments where tasks are performed by remote processing devices linked through a communications network. In a distributed computing environment, the program modules may be located in local and/or remote memory storage devices.

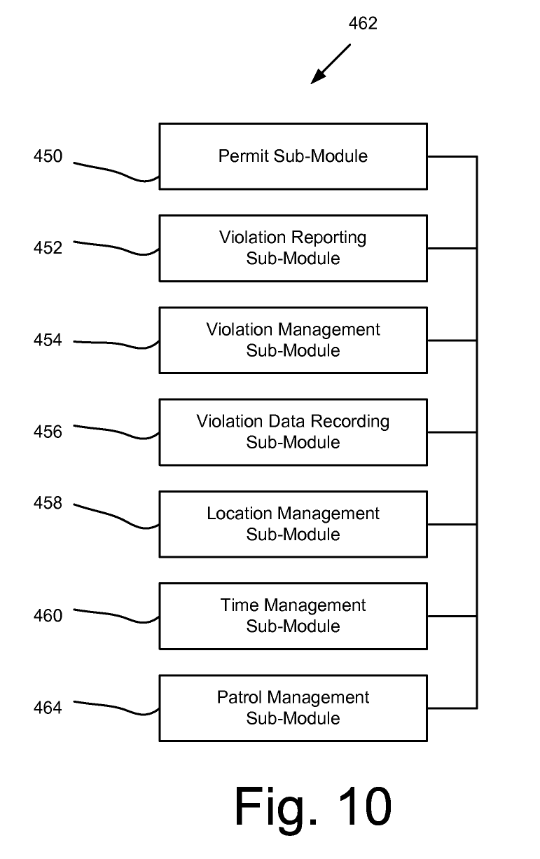

FIG. 10 is a schematic illustration of an exemplary bloc diagram depicting a plurality of program sub-modules 462 in accordance with an embodiment of the present invention. A user may use one or more of the sub-modules 462 when using the application. The program sub-modules include a permit sub-module 450, a violation-reporting sub-module 452, a violation management sub-module 454, a violation data-recording sub-module 456, a location management sub-module 458, a time management sub-module 460 and a patrol management sub-module 464. Program modules may include routines, programs, objects, components, data structures, applets, WEB 2.0 type of evolved networked centered applications, etc. that perform a task(s) or implement particular abstract data types. Moreover, these skilled in the art will appreciate that at least some aspects of the present invention may be practiced with other configurations, including hand-held devices, multiprocessor system, microprocessor-based or programmable consumer electronics, network computers, minicomputers, set top boxes, mainframe computers, personal computers, laptops, personal digital assistants, cell phones, gaming console and the like. At least some aspects of the present invention may also be practiced in distributed computing environments where tasks are performed by remote processing devices linked through a communications network. In a distributed computing environment, program modules may be located in local and/or remote memory storage devices.

FIG. 11 is a schematic illustration of an exemplary user interface in accordance with an embodiment of the present invention. The user interface presents a series of potential violation events 500 illustrated on a row that have been previously selected by the community's representative from a list of potential violation events provided to the community's representative to a selected sub-contractor. Each potential violation event 500 is associated with a number of sequential violation event treatments 510. For instance, the first violation treatment 510.1 provides a first violation event remedy 502 and a delay 504 associated therewith. Similarly, a second violation treatment 510.2 provides a second violation event remedy 506 and a delay 508 associated therewith. Additional violation treatments 510 could be added although only two violation treatments 510 are illustrated in the present embodiment.

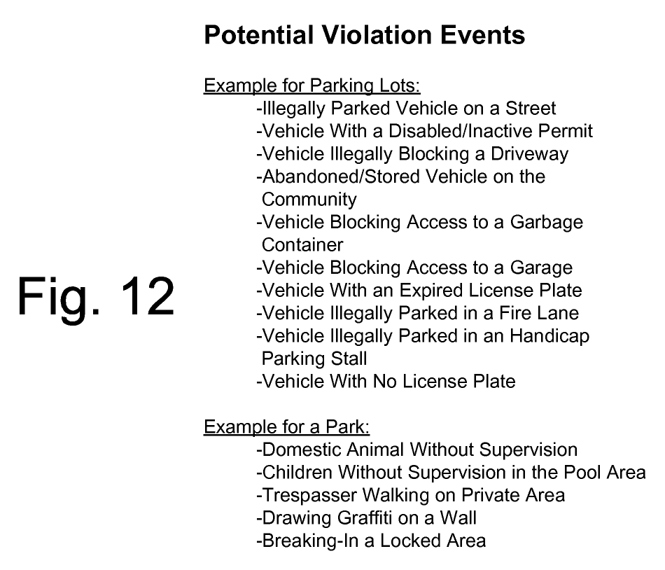

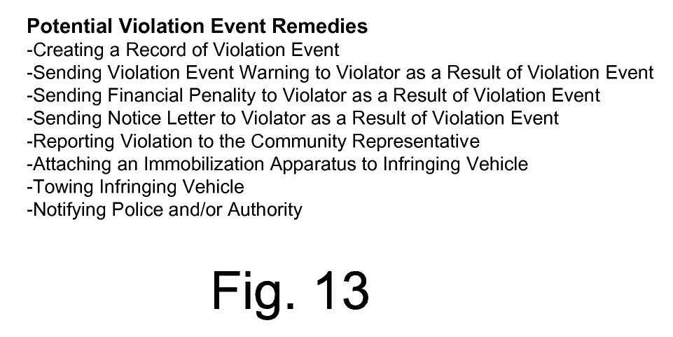

FIG. 12 is a non-exhaustive list of exemplary potential violation events. The potential events are separated in various categories illustrating typical possible uses of the present invention. In the present situation FIG. 12 depicts potential violation events in the field of parking management and park management. And FIG. 13 illustrates a non-exhaustive list of exemplary potential violation events remedies. In the present situation FIG. 13 depicts potential violation events in the field of parking management and park management. A skilled reader will understand that other violation events and violation event remedies in various fields of application could be use and still remain within the scope of the present patent application.

The features provided in the present application can be applied to other types of communities such as apartment building, condominium, town homes, cluster homes, single dwelling communities, multi-units dwelling communities, single dwelling co-op style communities, multi-units co-op style communities, government managed residential and non-residential building, shopping center, strip mall, any other area comprised of multiple resident living, any other area comprised of multiple-commercial units, parking facilities where garages, tandem parking apparatus, covered parking, car ports, parks, golf courses, school and any other assigned or unassigned areas without departing from the scope of the present application.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. A method of enforcing community covenant rules by managing events within a community using a computer system, the method comprising:
providing a plurality of potential violation events;
selecting at least one potential violation event from the plurality of potential violation events; and
associating a violation event remedy with the selected at least one potential violation event.

2. The method of claim 1, further comprising a delay adapted to be associated with the violation event remedy, the violation event remedy being adapted to be enforced when the delay associated therewith is expired.

3. The method of claim 1, wherein the community covenant rules are, at least in part, community covenant parking rules.

4. The method of claim 1, wherein the violation event remedy is a financial penalty.

5. The method of claim 4, wherein the financial penalty is adapted to be paid electronically.

6. The method of claim 5, wherein the system is adapted to manage electronic money transactions and the method further comprises sending a request for debiting one of a money account and a credit card.

7. The method of claim 3, wherein the violation event remedy is a vehicle immobilization apparatus.

8. The method of claim 3, wherein the violation event remedy is towing the vehicle.

9. The method of claim 3, wherein the violation event remedy is a violation letter.

10. The method of claim 3, wherein the violation event remedy is a notice.

11. The method of claim 3, wherein the violation event remedy is an incident report.

12. The method of claim 2, wherein the violation event remedy is a first violation event remedy and the delay associated therewith is a first delay, the method further comprising
associating a second violation event remedy to the at least one of the selected at least one potential violation event; and
associating a second delay with the associated to the second violation event remedy, the second violation event being adapted to be enforced after the first violation event remedy has been enforced.

13. The method of claim 2, further comprising a reset time limit adapted to reset the delay.

14. The method of claim 1, further comprising collecting and recording violation event evidences.

15. The method of claim 1, wherein the method is adapted to be carried out in a client-server environment.

16. A user graphical interface adapted to display controls for managing enforcement of community covenant rules, the user graphical interface comprising:
a potential violation events display area adapted to display a plurality of user-selectable potential violation events;
a violation event remedies display area adapted to display a plurality of user-selectable violation event remedies; and
a delay display area adapted to receive instructions defining a delay adapted to be associated with a violation event remedy.

17. The system of claim 16, wherein the user interface module is adapted to be use through an Internet browser.

18. A system for enforcing community covenant rules and guidelines comprising:
a user interface module adapted to receive instructions from a user;
a violation events module adapted to receive instructions from the user interface module;
a violation event remedies module adapted to receive instructions from the user interface module;
a delay module adapted to receive instructions from the user interface module.

19. The system of claim 18, wherein the user interface module is adapted to be use through a browser.

20. The system of claim 18, further comprising a GPS module adapted to define the geographical location of a violation event.
